(19) United States
(12) Patent Application Publication
(10) Pub. No.: US 2009/0173549 A1
(43) Pub. Date: Jul. 9, 2009

(54) Platform Scale

(75) Inventor: Mordechai Lev, West Bloomfield, MI (US)

Correspondence Address: BROOKS KUSHMAN P.C., 1000 TOWN CENTER, TWENTY-SECOND FLOOR, SOUTHFIELD, MI, 48075, US

(73) Assignee: FKA DISTRIBUTING CO. D/B/A HOMEDICS, INC., Commerce Township, MI (US)

(21) Appl. No.: 11/971,264

(22) Filed: Jan. 9, 2008

(51) Int. Cl. G01G 19/00

(52) U.S. Cl. 177/25.11

(57) ABSTRACT

A scale for measuring weight has a weight measurement device to be supported by an underlying surface. A generally planar platform cooperates with the weight measurement device so a load on the platform is measured by the weight measurement device. The scale has a display for displaying a measured weight. The scale may have a battery powering the display and a removable battery powering an ancillary feature. The scale display may have three columns so a measured weight appears to scroll. The scale may have a processor outputting an audio signal when the measured weight is displayed and a speaker conveying a sound effect. The scale display may be on a majority of the surface indicating the measured weight for a time after load removal. The scale display may display a temperature when not displaying the measured weight and the scale may have an external temperature sensor and a receiver.

### BACKGROUND

1. Technical Field

The invention relates generally to a platform scale for displaying a measured weight of a user.

### BRIEF DESCRIPTION OF THE DRAWINGS

FIG. 1 is a top plan view of a platform scale with a display according to an embodiment of the present invention;

FIG. 2 is a top plan view of a platform scale with a display according to another embodiment of the present invention;

FIG. 3 is a side elevation view of the scale of FIG. 1 or FIG. 2;

FIG. 4 is a top plan view of a platform scale according to an embodiment of the present invention, illustrated with a platform removed therefrom;

FIG. 5 is a flowchart of a process of measuring a weight of a user on a platform scale according to an embodiment of the present invention;

FIG. 6 is a top plan view of a platform scale according to another embodiment of the present invention;

FIG. 7 is a top plan view of a platform scale according to yet another embodiment of the present invention;

FIG. 8 is an illustration of a display sequence of the display of FIG. 7;

FIG. 9 is to plan view of a platform scale according to another embodiment of the present invention;

FIG. 10 is an illustration of a display sequence of the display of FIG. 9;

FIG. 11 is top plan view of a platform scale according to yet another embodiment of the present invention; and

FIG. 12 is top plan view of a platform scale and an external temperature measurement device according to an embodiment of the present invention.

### DETAILED DESCRIPTION OF EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some figures may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

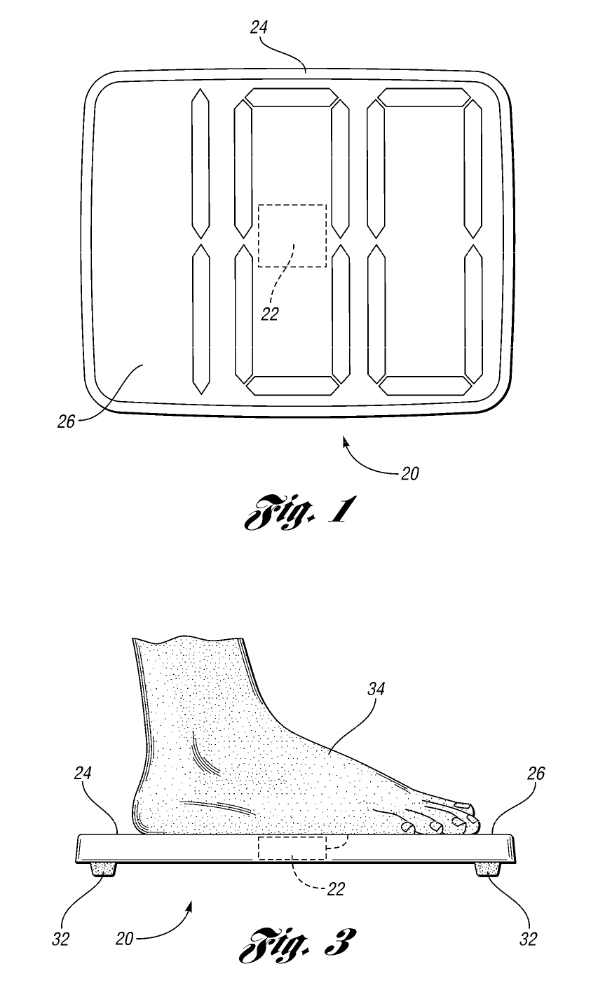

Referring to FIG. 1, a platform scale is illustrated and is referenced generally by numeral 20. The scale 20 is adapted to rest upon an underlying support surface and can be employed to measure a weight of a user when the user is on the scale 20.

The scale 20 includes a platform 24 having a generally planar surface 26 for receiving an object thereon, such as feet of a user. The platform 24 may include downward extending sidewalls for covering the underlying structural components of the scale 20 and any otherwise exposed operational components of the scale 20.

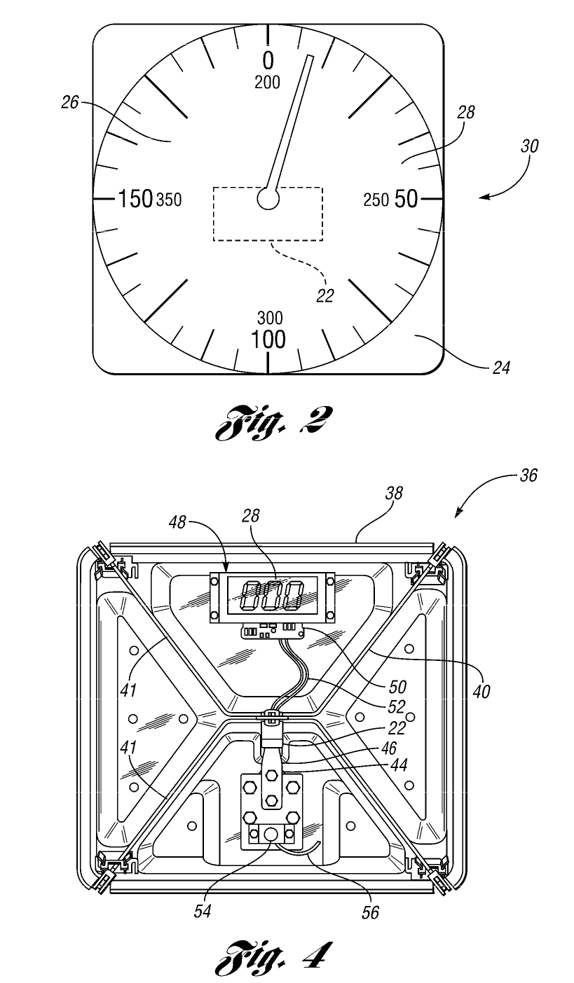

In one embodiment, the scale 20 has a display 28, which is connected with the weight measurement device 22 for displaying a measured weight. The display 28 occupies a majority of the generally planar surface 26 to provide easy viewing for the user of the measured weight on the display 28. The display 28 is digital as illustrated in the present embodiment. In another embodiment, illustrated in FIG. 2, the display 28 may be mechanical. Digital and mechanical displays having a reduced area are known in the art, as disclosed U.S. Pat. No. 7,214,892, which issued on May 8, 2007 to Williamson and U.S. Pat. No. 7,235,746, which issued on Jun. 26, 2007 to Williamson, and are each incorporated by reference herein.

Referring to FIG. 3, the platform scale 20 of FIG. 1 or FIG. 2 is illustrated with a user's feet 34 provided thereon. The scale 20 is adapted to be supported by an underlying support surface through the use of supports 32. Of course, any suitable manner of supporting the platform scale 20 are contemplated within the scope of the present invention.

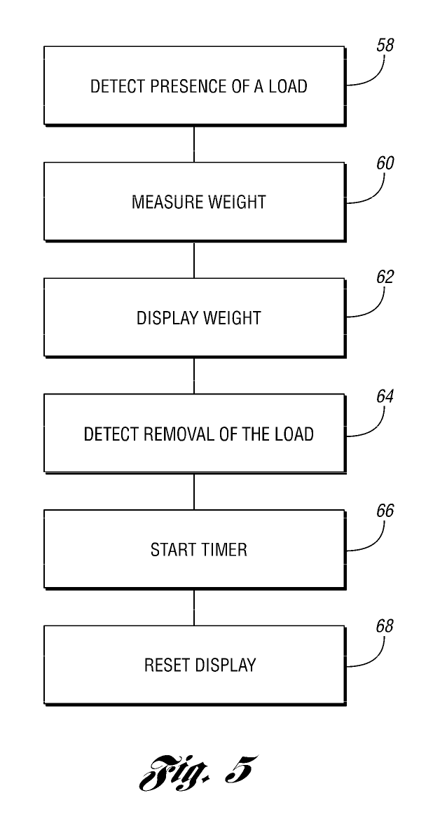

With reference now to FIG. 4, a scale 36 is illustrated with the platform 24 removed. The scale 36 includes a weight measurement device 22, which is supported by a base 38 for resting upon an underlying support surface. The weight measurement device 22 is similar to weight sensing mechanisms disclosed in U.S. Pat. No. 7,214,892 and U.S. Pat. No. 7,235,746, which have been incorporated by reference. In one embodiment, the base 38 is formed from steel and is fabricated from a stamping operation. Since the base 38 has a similar overall size and shape of that of a platform 24, the base 38 and the platform 24 can be fabricated from a common stamping operation. Of course, the base 38 and the platform 24 often require differing hole patterns or other features, and thus, these different features can be provided in subsequent stamping operations.

In one embodiment, the scale 36 is provided with a lever assembly 40 and a weight measurement device 22. The lever assembly 40 receives and supports the platform 24. When an object is placed upon the platform 24, the load is distributed through the lever assembly 40 to the weight measurement device 22. The weight of the user is measured by the weight measurement device 22 and the measurement is conveyed to the display, which may occupy the majority of the generally planar surface 26. As illustrated, the lever assembly 40 includes fulcrum legs 41that extend through the base 38 and are supported by the underlying support surface.

Alternatively, the base 38 may rest directly upon the underlying support surface. Legs, contact pads, or the like can be affixed to the underside of the base 38 for engaging the underlying support surface. In this alternative arrangement, the platform 24 translates relative to the base 38 as a function of the weight applied thereon. The platform 24 may be maintained assembled to the base 38 by a plurality of hookup spring assemblies, which are well known in the art. Hookup spring assemblies are disclosed in detail in U.S. Pat. No. 5,731,548, which issued to Williamson et al. on Mar. 24, 1998, which is hereby incorporated in its entirety by reference herein.

The weight measurement device 22 illustrated includes a load cell having a cantilevered beam 44 that is fastened to the base 38. The load cell includes a strain gauge 46 for measuring the strain of the beam 44. Of course, the invention contemplates any weight sensing mechanism for consequently providing an appropriate output. For example, a weight measurement device may be utilized such as the one disclosed in U.S. Pat. No. 5,141,065, which issued on Aug. 25, 1992 to Maxwell et al. The Maxwell et al. U.S. Pat. No. 5,141,065 patent is incorporated in its entirety by reference herein.

The scale 36 may also include a modular controller 48, which powers, controls, and displays the result of the weight measurement of the scale 36. The controller 48 includes the display 28, a printed circuit board (PCB) 50, and a battery housing (not shown). Wiring 52 connects the PCB 50 with the weight measurement device 22. The controller 48 may include a power-on switch 54 with wires 56 that can be directly wired to the PCB 50.

FIG. 5 depicts a general overview of a process for measuring a weight and providing a display of the weight on a platform scale. As depicted, the first step 58 is detecting the presence of a load. Step 60 is measuring the weight of the load that is detected. The weight measured in step 60 is then displayed in step 62. Removal of the load is detected in step 64. A timer then may be started as in step 66. After a predetermined period of time passes, the display is reset as in step 68.

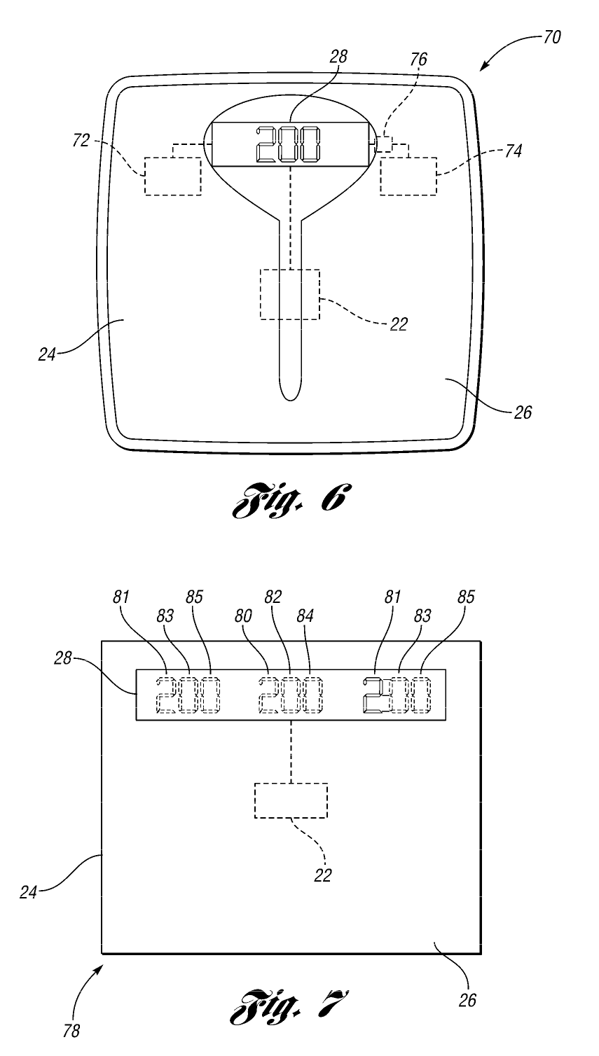

Referring now to FIG. 6, another scale embodiment is illustrated and referenced generally by numeral 70. The scale 70 has a first battery 72 for powering the display 28. The scale 70 also has a second battery 74 for powering an ancillary feature 76. The second battery 74 may be located in the scale 70 so that it may be easily removed from the scale 70. The second battery 74 may be rechargeable so that it may be used multiple times. The ancillary feature 76 may be a light source for illuminating the digital display 28.

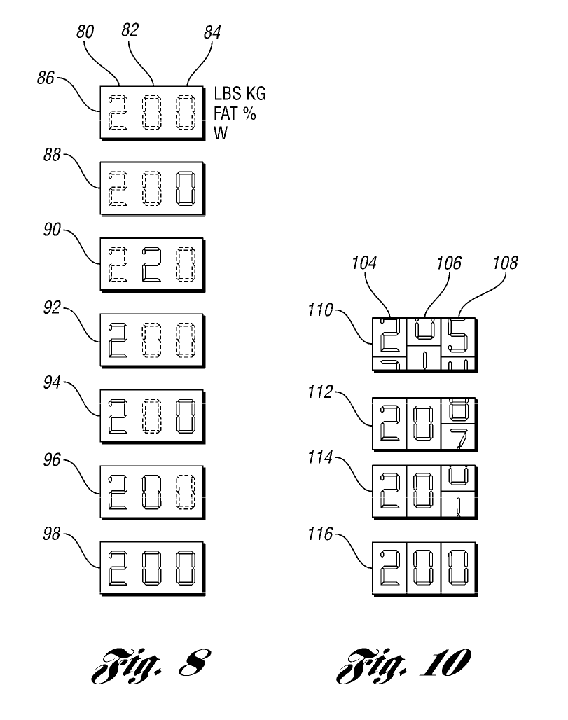

Referring now to FIG. 7, an embodiment of a scale is illustrated and generally referenced by numeral 78. As depicted, the display 28 of the scale 78 has three central columns 80, 82, 84. The three central columns 80, 82, 84 each display one number. The display 28 may have additional columns 81, 83, 85 on each lateral side. Each column 81, 83, 85 displays one number and may display a letter or other symbol.

After the weight measurement device 22 measures the weight of a user, a signal is sent to the display 28 so that the display 28 scrolls the determined weight laterally across the display 28 so that the number appears to move laterally across the display from column to column. The lateral movement from column to column on the display 28 gives an appearance of scrolling of the measured weight. The display 28 also scrolls a measurement of a body fat percentage and a body water percentage on the display 28 during various modes as selected by a user.

Referring now to FIG. 8, the scrolling display of 28 of FIG. 7 is illustrated sequentially from numbers 86 through 98 showing the movement across three columns 80, 82, 84. The scrolling may appear to be incremental as illustrated. In display 86, no numbers are provided in the columns 80, 82, 84. In display 88, a number is provided in column 84. In display 90, the number has moved from column 84 to column 82. In display 92, the number has moved from column 82 to 80. In display 94, a second number is now provided in column 84. In display 96, the number has moved from column 84 to 82. Finally, in display 98, a number is provided in all three columns 80, 82, 84 to display a measured weight. Display labels 100 may also be provided near the display to show the type of measurement provided on the display. In one embodiment, the display labels 100 are each painted on the display 90. In another embodiment, the display labels 100 are visible when illuminated, either independently or collectively. Of course any suitable display labels 100 are contemplated within the scope of the present intention.

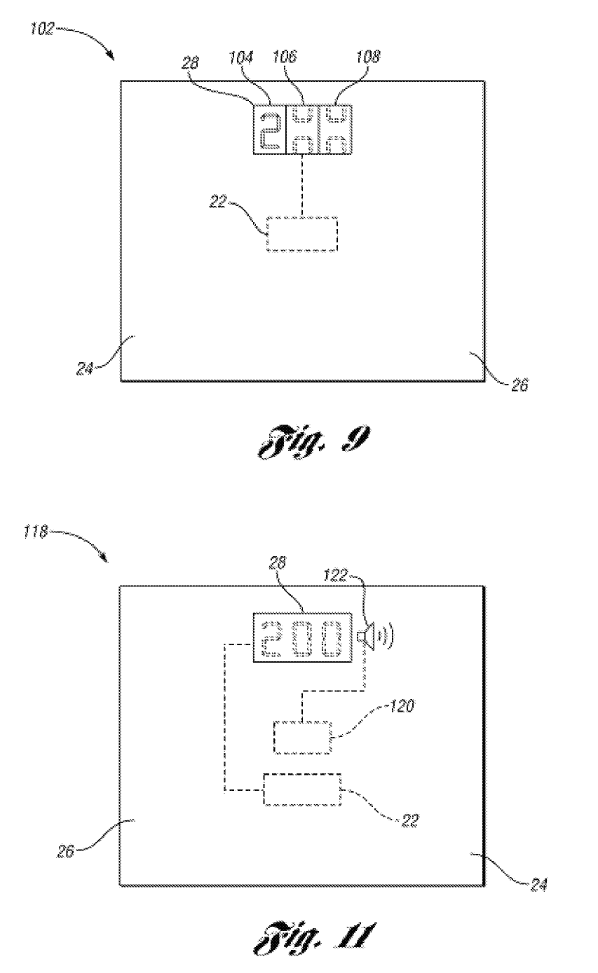

With reference now to FIG. 9, an embodiment of a scale 102 is illustrated with a display 28. The display 28 has three columns 104, 106, 108. The columns 104, 106, 108 each display a number at a given time. The number in each column 104, 106, 108 scroll longitudinally.

Referring now to FIG. 10, the display 28 of FIG. 9 is illustrated sequentially in displays 110 through 116. Each display 110 through 116 has at least three columns 104, 106, 108 each capable of displaying one number. In display 110, all columns 104, 106, 108 are scrolling longitudinally. In display 112, column 104 is displaying only one number while columns 106 and 108 are scrolling longitudinally. In display 114, columns 104 and 106 are displaying one number while column 108 is still scrolling longitudinally. In display 116, all columns 104, 106, 108 are displaying one number. Displays 110 through 116 sequentially illustrate each number being displayed in each column 104, 106, 108 may be incremental.

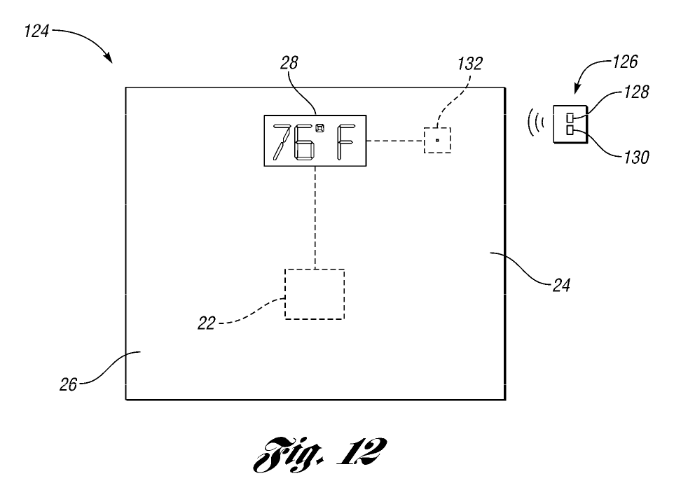

Referring now to FIG. 11, a scale according to another embodiment is illustrated and referenced generally by numeral 118. The scale 118 includes a processor 120. The processor 120 outputs an audio signal in response to a measured weight being displayed on the display 28. The scale 118 has a speaker which is connected with the processor 120 for playing sound effects in response to the audio signal provided from the processor 120. In one embodiment, the sound effects are reproductions of fireworks. In another embodiment, the sound effects are reproductions of slot machines.

In another embodiment, the processor outputs an audio signal while the measured weight is being displayed on the display 28. The display 28 may appear to scroll longitudinally while displaying the measured weight to create an appearance and corresponding sounds of a slot machine.

With reference to FIG. 12, an embodiment of a scale 124 having an external temperature measurement device 126 is illustrated. The scale 124 and the external temperature measurement device 126 are in wireless communication with each other.

The external temperature measurement device 126 has a sensor 128 and a transmitter 130. The sensor 128 measures a temperature of a corresponding environment or ambient air. The sensor 128 is connected with the transmitter 130 so that the transmitter 130 provides a wireless transmission to a receiver 132 in the scale 124. The receiver 132 in the scale 124 receives the wireless transmission of the transmitter 130. The receiver 132 is connected with the display 28 so that the display shows the temperature measured by the external temperature measurement device 126 while the display 28 is not displaying a measured weight.

In another embodiment, the display also shows a time, date, humidity, and temperature when not displaying a measured weight. The humidity is measurable by a sensor (not shown), which can be mounted in the external measurement device 126.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A scale for measuring weight comprising:
a weight measurement device adapted to be supported by an underlying surface;
a platform having a generally planar surface, the platform cooperating with the weight measurement device so that a load imparted upon the platform is measured by the weight measurement device;
a digital display on the platform cooperating with the weight measurement device for displaying a measured weight;
a first battery provided in the scale for powering the display; and
a second battery provided in the scale for powering an ancillary feature of the scale, the second battery being removable from the scale.

2. The scale of claim 1 wherein the second battery is rechargeable.

3. The scale of claim 1 wherein the ancillary feature is a light source for illuminating the display.

4. The scale of claim 1 wherein at least one of the first and second batteries is formed from a material other than lithium.

5. A scale for measuring weight comprising:
a weight measurement device adapted to be supported by an underlying surface;
a platform having a generally planar surface, the platform cooperating with the weight measurement device so that a load imparted upon the platform is measured by the weight measurement device; and
a digital display on the platform cooperating with the weight measurement device for displaying a measured weight providing at least three columns, each of the at least three columns displaying at least one number such that the measured weight appears to scroll over the display.

6. The scale of claim 5 wherein the display scrolls a measurement of a body fat percentage across the display.

7. The scale of claim 5 wherein the display scrolls a measurement of a body water percentage across the display.

8. The scale of claim 5 wherein at least one number corresponding to the measured weight scrolls laterally across the display such that the measured weight appears to move laterally across the display.

9. The scale of claim 8 wherein each number displayed in each column appears one at a time.

10. The scale of claim 5 wherein the measured weight scrolls longitudinally across the display such that the measured weight appears to move longitudinally across the display.

11. The scale of claim 10 wherein each number displayed in each column appears incrementally.

12. A scale for measuring weight selected from the group consisting of:
a weight measurement device adapted to be supported by an underlying surface;
a platform having a generally planar surface, the platform cooperating with the weight measurement device so that a load imparted upon the platform is measured by the weight measurement device;
a display on the platform cooperating with the weight measurement device for displaying a measured weight;
a processor provided within the scale, the processor outputting an audio signal in response to the measured weight being displayed;
a speaker provided in the scale in communication with the processor for audibly conveying a reproduction of a slot machine in response to the audio signal; and
a speaker provided in the scale in communication with the processor for audibly conveying a reproduction of fire works in response to the audio signal.

13. The scale of claim 12 wherein the signal is provided in response to a specified measured weight.

14. The scale of claim 13 wherein a user inputs the specified measured weight to the processor to provide the signal.

15. The scale of claim 12 wherein the display includes at least three columns, each of the at least three columns displaying at least a number; and
wherein at least one number scrolls longitudinally on the display while the measured weight is being displayed.

16. The scale of 12 wherein each number displayed in each column appears incrementally to display a total weight when all columns stop scrolling.

17. A scale for measuring weight comprising:
a weight measurement device adapted to be supported by an underlying surface;
a platform having a generally planar surface, the platform cooperating with the weight measurement device so that a load imparted upon the platform is measured by the weight measurement device; and
a display on the platform cooperating with the weight measurement device for displaying a measured weight, the display occupying at least a majority of the generally planar surface, wherein the display indicates the measured weight for a predetermined period of time once the load is removed.

18. The scale of claim 17 wherein the display is digital.

19. The scale of claim 17 wherein the display is mechanical.

20. A scale for measuring weight comprising:
a weight measurement device adapted to be supported by an underlying surface;
a platform having a generally planar surface, the platform cooperating with the weight measurement device so that a load imparted upon the platform is measured by the weight measurement device;
a display on the platform cooperating with the weight measurement device for displaying a measured weight and a temperature of a corresponding environment when not displaying the measured weight;
an external temperature measurement unit comprising:
a sensor provided in the temperature measurement unit which measures the temperature of the corresponding environment, and
a transmitter provided in the temperature measurement unit, the transmitter in communication with the sensor for receiving the temperature from the sensor and transmitting a wireless transmission of the temperature; and
a receiver provided within the scale in communication with the display for receiving the wireless transmission of the transmitter.

21. The scale of claim 21 wherein the display provides time, date, humidity and temperature when not displaying a measured weight.
